(19) United States
(12) Patent Application Publication
(10) Pub. No.: US 2023/0042838 A1
(43) Pub. Date: Feb. 9, 2023

(54) METHOD FOR DATA PROCESSING, DEVICE, AND STORAGE MEDIUM

(71) Applicant: BEIJING BAIDU NETCOM SCIENCE TECHNOLOGY CO., LTD., Beijing (CN)

(72) Inventor: Jianbo ZHU, Beijing (CN)

(73) Assignee: BEIJING BAIDU NETCOM SCIENCE TECHNOLOGY CO., LTD., Beijing (CN)

(21) Appl. No.: 17/879,906

(22) Filed: Aug. 3, 2022

(30) Foreign Application Priority Data
Aug. 6, 2021 (CN) 202110902664.7

(51) Int. Cl. G06N 3/04

(52) U.S. Cl. CPC G06N 3/04

(57) ABSTRACT

A method for data processing, an electronic device, and a computer-readable storage medium, which relate to the field of computers. The method includes: acquiring a scheduling information for a perception model based on a user application; determining, based on the scheduling information for the perception model, a scheduling set of the perception model, where the scheduling set of the perception model comprises one or more sub-models of a plurality of sub-models of the perception model; and running, based on perception data from a data collection device, the one or more sub-models of the scheduling set of the perception model, so as to output one or more perception results corresponding to the one or more sub-models.

This application claims the benefit of Chinese Patent Application No. 202110902664.7 filed on Aug. 6, 2021, the whole disclosure of which is incorporated herein by reference.

### TECHNICAL FIELD

Embodiments of the present disclosure relate to a field of computers, and in particular, to a method for data processing, a device, and a storage medium.

### BACKGROUND

With the development of artificial intelligence technology, autonomous driving has attracted people's attention and become a research hotspot. Automated parking is an important part of autonomous driving and usually has functions such as environment perception, vehicle positioning, planning and decision, and vehicle control. A speed of acquiring a perception result and an accuracy of the perception result are key points for meeting user needs for fast and accurate automated parking.

At present, neural network models are used for processing environmental data to acquire accurate perception results. However, processing a large amount of data by a neural network model may cause a great delay in outputting a perception result, thereby still failing to meet the user needs.

### SUMMARY

According to embodiments of the present disclosure, a solution for data processing is proposed.

According to an aspect of the present disclosure, there is provided a method for data processing. The method includes: acquiring a scheduling information for a perception model based on a user application; determining, based on the scheduling information for the perception model, a scheduling set of the perception model, where the scheduling set of the perception model includes one or more sub-models of a plurality of sub-models of the perception model; and running, based on perception data from a data collection device, the one or more sub-models of the scheduling set of the perception model, so as to output one or more perception results corresponding to the one or more sub-models.

According to another aspect of the present disclosure, there is provided an electronic device. The electronic device includes at least one processor, and a storage device configured to store at least one program that, when executed by the at least one processor, enables the at least one processor to implement the method described above.

According to another aspect of the present disclosure, there is provided a non-transitory computer-readable storage medium having computer instructions stored thereon, where the computer instructions, when executed, allow the at least one processor to implement the method described above.

It should be understood that content described in this section is not intended to identify key or important features in embodiments of the present disclosure, nor is it intended to limit the scope of the present disclosure. Other features of the present disclosure will be easily understood through the following description.

These embodiments and other embodiments will be discussed in combination with the drawings.

### BRIEF DESCRIPTION OF THE DRAWINGS

The above and other features, advantages and aspects of embodiments of the present disclosure will become more apparent in combination with the drawings and with reference to the following detailed description. In the drawings, same or similar reference numerals indicate same or similar elements.

FIG. 1 shows a schematic block diagram of a conventional data processing system.

FIG. 2 shows a schematic block diagram of a data processing system according to embodiments of the present disclosure.

FIG. 3 shows a flowchart of an example of a method for data processing according to embodiments of the present disclosure.

FIG. 4 shows a process diagram of an example of an internal processing of perception according to embodiments of the present disclosure.

FIG. 5 shows a flowchart of another example of a method for data processing according to embodiments of the present disclosure.

FIG. 6 shows a block diagram of an example of an apparatus for data processing according to embodiments of the present disclosure.

FIG. 7 shows a block diagram of a computing device used to implement embodiments of the present disclosure.

### DETAILED DESCRIPTION OF EMBODIMENTS

Embodiments of the present disclosure are described in detail below with reference to the drawings. Embodiments of the present disclosure are shown in the drawings, however, it should be understood that the present disclosure may be implemented in various forms and should not be construed as limited to embodiments set forth herein, but rather these embodiments are provided for a more thorough and complete understanding of the present disclosure. It should be understood that the drawings and embodiments of the present disclosure are only for exemplary purposes, and are not intended to limit the protection scope of the present disclosure.

In the description of embodiments of the present disclosure, the term “including” and similar terms should be understood as open-ended inclusion, that is, “including but not limited to”. The term “based on” should be understood as “at least partially based on.” The term “an embodiment” or “this embodiment” should be understood as “at least one embodiment.” The terms “first,” “second,” and the like may refer to different or the same objects. The following may also include other explicit and implicit definitions.

In embodiments of the present disclosure, the term “model” is capable of processing an input and providing a corresponding output. Taking a neural network model as an example, it generally includes an input layer, an output layer, and one or more hidden layers between the input layer and the output layer. A model used in a deep learning application (also called “a deep learning model”) generally includes a plurality of hidden layers, so that a depth of the network is extended. Layers of the neural network model are connected in order, so that an output of a previous layer is used as an input of a latter layer, the input layer receives an input of the neural network model, and an output of the output layer is used as a final output of the neural network model. Each layer of a neural network model includes one or more nodes (also called processing nodes or neurons), each of which processes an input from a previous layer. Herein, the terms “neural network”, “model”, “network”, and “neural network model” are used interchangeably.

In the technical solution of the present disclosure, the collection, storage, use, processing, transmission, provision, disclosure, and application of the user's personal information involved are all in compliance with relevant laws and regulations, take essential confidentiality measures, and do not violate public order and good customs.

In the technical solution of the present disclosure, authorization or consent is obtained from the user before the user's personal information is obtained or collected.

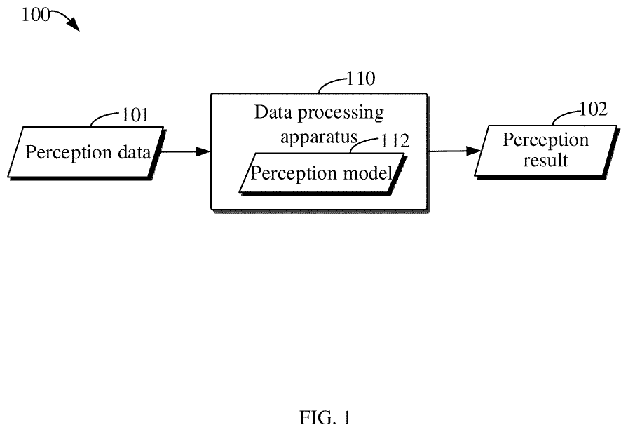

Referring to FIG. 1, a schematic block diagram of a conventional data processing system 100 is shown therein. The data processing system 100 in FIG. 1 includes a data processing apparatus 110. The data processing apparatus 110 may include or be deployed with a perception model 112 based on a neural network. It should be understood that the data processing apparatus 110 may further include or be deployed with other models.

As shown in FIG. 1, the data processing apparatus 110 may be used to receive perception data 101. The perception data 101 includes perception data for different scenarios such as a drivable region, a parking space, and an obstacle. The data processing apparatus may generate, based on the perception data 101, a perception result 102 by using the perception model 112. The perception result 102 may include information associated with the different scenarios, such as a size of the drivable region, a presence or an absence of a vehicle blocker, an orientation of an obstacle.

As mentioned above, the perception model needs to process a large amount of perception data for the scenarios such as a drivable region, a parking space, and an obstacle. However, in existing technologies, all perception results acquired through processing of the perception model are packaged and then sent to a user terminal, as a result, the user terminal fails to acquire data on demand. In addition, the perception results are packaged and sent to the user terminal after models for all the scenarios have been run in series, causing the user terminal a large delay in acquiring the perception results.

According to an embodiment of the present disclosure, a solution of data processing is proposed. In this solution, after a scheduling information for a perception model based on a user application is acquired, a scheduling set of the perception model is determined based on the scheduling information for the perception model. The scheduling set of the perception model includes one or more sub-models of a plurality of sub-models of the perception model. The one or more sub-models of the scheduling set of the perception model are run based on perception data from a data collection device, so as to output one or more perception results corresponding to the one or more sub-models.

In embodiments of the present disclosure, each of the plurality of sub-models of the perception model, or sub-models with a same function from the plurality of sub-models of the perception model may be independently scheduled and run according to the user application, so as to output the one or more perception results corresponding to the one or more sub-models, thereby effectively decoupling perception results for different scenarios. Advantageously, a perception result of each model is sent to the user terminal as soon as the model finishes running, without waiting for results of other models. Therefore, according to embodiments of the present disclosure, the delay of the user terminal in acquiring the perception results may be greatly reduced, and the user terminal may acquire data on demand, so that the content of the message is more intuitive.

Embodiments of the present disclosure will be described in detail below with reference to the drawings.

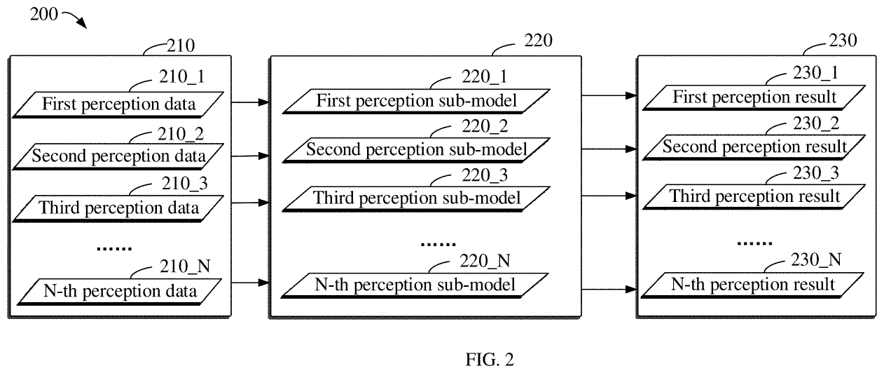

FIG. 2 shows a schematic block diagram of a data processing system 200 according to embodiments of the present disclosure. In FIG. 2, the data processing system 200 includes a data processing apparatus 220. The data processing apparatus 220 is similar to the data processing apparatus 110 shown in FIG. 1, and includes a perception model for processing perception data as well. The difference between the two apparatuses is that the perception model in FIG. 2 may be atomized, namely including a plurality of sub-models that may be scheduled independently, such as a first perception sub-model 220_1, a second perception sub-model 220_2 . . . and an Nth perception sub-model 220_N. In embodiments, the perception model may include at least one selected from: a model for drivable region, a model for target two-dimensional information detection, a model for target three-dimensional information detection, a model for parking space detection and vehicle blocker detection, a model for manual sign detection, a model for feature point detection based on deep learning, a model for camera stain detection, or the like. In embodiments, the perception model may further include perception sub-models for other uses or functions. The scope of the present disclosure is not limited in this regard.

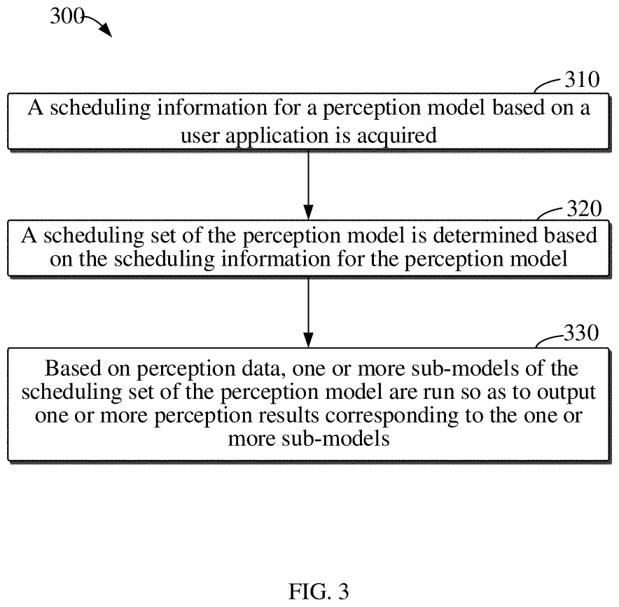

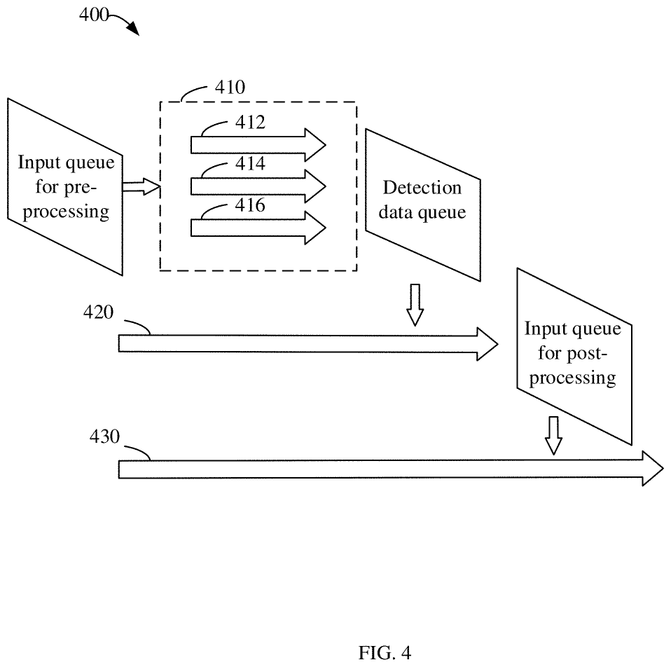

As shown in FIG. 2, a perception data set 210 includes various perception data for different scenarios as described above, such as first perception data 210_1, second perception data 210_2 . . . and Nth perception data 210_N, and the various perception data in the perception data set are respectively input to the plurality of perception sub-models. Based on the one or more perception data 210_1 to 210_N, one or more perception sub-models 220_1 to 220_N are independently scheduled and run, so as to output one or more perception results corresponding to the one or more perception sub-models 220_1 to 220_N, such as a first perception result 230_1, a second perception result 230_2 . . . and a Nth perception result 230_N. The above-mentioned one or more perception results 230_1 to 230_N adopt a same data structure, but are labeled with different topic names. In embodiments, a topic of a perception result for the model for drivable region is labeled as perception_fs, and a topic of a perception result for the model for target two-dimensional information detection is labeled as perception_2dbbox. The above topic name is determined according to an actual running model. By labeling topics of different results with different names, the perception results are more clear and intuitive, so that it is convenient for the user terminal to acquire data on demand. The present disclosure does not limit the label type here. Exemplary embodiments of the method for data processing will be described below in combination with FIGS. 3 to 4.

FIG. 3 shows a flowchart of an example of a method 300 for data processing according to embodiments of the present disclosure. For example, the method 300 may be performed by the system 200 as shown in FIG. 2. The method 300 will be described below in combination with FIG. 2. It should be understood that the method 300 may further include additional blocks not shown, and/or the method 300 may omit some of the blocks shown. The scope of the present disclosure is not limited in this regard.

As shown in FIG. 3, at block 310, a scheduling information for a perception model based on a user application is acquired. The scheduling information for the perception model includes information related to the running of the perception model, for example, indicating which perception sub-model is scheduled, which camera data is retrieved, and at which frame rate is the scheduled perception sub-model run. In embodiments, the scheduling information for the perception model may not include the running frame rate of the perception sub-model. In this case, the perception sub-model runs at a predefined frame rate. Since perception sub-models required by different user applications are not exactly the same, the scheduling information for the perception model may vary according to different user applications. In embodiments, the user application may include automated parking assist (APA), home automated valet parking (H-AVP), and public automated valet parking (P-AVP). In another embodiment, user applications may include applications related to other business requirements. The present disclosure does not limit any user application types here. Based on the atomized perception model, user applications with different business requirements may be supported under one system framework, so that the scalability of the data processing system may be improved.

At block 320, a scheduling set of the perception model is determined based on the scheduling information for the perception model. The scheduling set of the perception model includes one or more sub-models of the plurality of sub-models of the perception model as shown in FIG. 2. The one or more sub-models may be retrieved from an overall model set in a manner known in the art and then stored in a storage device as the scheduling set of the perception model. The present disclosure does not limit the retrieval method and storage device.

At block 330, based on the one or more perception data 210_1 to 210_N as shown in FIG. 2, the one or more sub-models 220_1 to 220_N of the scheduling set of the perception model are run, so as to output the one or more perception results 230_1 to 230_N corresponding to the one or more sub-models. The one or more sub-models of the scheduling set of the perception model may be run in parallel or in serial. In embodiments, running the one or more sub-models in serial refers to running the one or more sub-models sequentially in turn. Alternatively or additionally, the one or more sub-models may be selectively run in serial according to a model running frame rate. The following takes the perception model including four sub-models, such as A, B, C, and D as an example, to describe a running mode of the one or more sub-models running in serial, as shown in the following two segments of codes.

In code segment 1, the four sub-models of A, B, C, and D are run sequentially in turn. Running the sub-models in a loop like this may ensure that a perception result of each sub-model is sent to the user terminal with as little delay as possible.

### Code Segment 1

src0→run(A)→send(A)→topicA↓
src1→run(B)→send(B)→topicB↓
src2→run(C)→send(C)→topicC↓
src3→run(D)→send(D)→topicD↓
src4→run(A)→send(A)→topicA↓
src5→run(B)→send(B)→topicB↓
src6→run(C)→send(C)→topicC↓
src7→run(D)→send(D)→topicD↓
src8→run(A)→send(A)→topicA↓

Here, “src” in code segment 1 represents source data processed by the model, “run(·)” represents running a model, and “send(·)” represents sending perception data corresponding to the model.

In practice, if a frame rate of a sub-model needs to be controlled, the sub-model may be selectively run in each loop. In embodiments, if a running frame rate of the D sub-model is ½ of that of other sub-models, such as A, B, and C, the sub-models are run as shown in code segment 2.

### Code Segment 2

src0→run(A)→send(A)→topicA↓
src1→run(B)→send(B)→topicB↓
src2→run(C)→send(C)→topicC↓
src3→run(D)→send(D)→topicD↓
src4→run(A)→send(A)→topicA↓
src5→run(B)→send(B)→topicB↓
src6→run(C)→send(C)→topicC↓
src7→run(A)→send(A)→topicA↓
src8→run(B)→send(B)→topicB↓
src9→run(C)→send(C)→topicC↓
src10→run(D)→send(D)→topicD↓
src11→run(A)→send(A)→topicA↓
src12→run(B)→send(B)→topicB↓
src13→run(C)→send(C)→topicC↓
src14→run(A)→send(A)→topicA↓

Here, “src” in code segment 2 represents the source data processed by the model, “run(·)” represents running a model, and “send(·)” represents sending perception data corresponding to the model.

In this way, perception sub-data output by a perception sub-model is sent to the user terminal as soon as the perception sub-model finishes running, thereby greatly reducing the delay caused by the user terminal waiting for the perception results. Moreover, the model running frame rate may be controlled by changing the running mode of the sub-models.

Running a plurality of sub-models in parallel will be described below in combination with FIG. 4.

FIG. 4 shows a process diagram of an example of internal processing 400 of perception according to embodiments of the present disclosure.

In FIG. 4, the internal processing 400 of perception includes three processing threads in parallel, such as a pre-processing thread 410, a model inference thread 420, and a post-processing thread 430. As shown in FIG. 4, an input queue for pre-processing including the perception data as shown in FIGS. 2 to 3 is input to the pre-processing thread 410. The pre-processing thread 410 may include a plurality of sub-threads to optimize the perception data. In embodiments, the pre-processing thread 410 may include a surround view stitching thread 412, a crop zoom thread 414, and a distortion eliminating thread 416. The above-mentioned plurality of sub-threads in the pre-processing thread 410 may be implemented in parallel, so as to provide support for implementing the plurality of sub-models running in parallel.

A data queue output by the pre-processing thread is input to the model inference thread 420 as a detection data queue. The model inference thread 420 may be implemented by, for example, a field programmable gate array (FPGA), thereby enabling both pipeline parallelism and data parallelism as described above.

The data queue output by the model inference thread is input to the post-processing thread 430 as an input queue for post-processing, so as to prepare for sending to the user terminal. The post-processing thread 430 includes, but is not limited to, sub-threads such as a parsing sub-thread. A plurality of sub-threads of the post-processing thread 430 may be implemented in parallel, so as to provide support for implementing the plurality of sub-models running in parallel.

It should be understood that the internal processing 400 of perception as shown in FIG. 4 is merely illustrative and is not intended to limit the scope of the present disclosure. The internal processing 400 of perception may also include more or fewer threads, and the pre-processing thread 410 and the post-processing thread 430 may also include more or fewer sub-threads that may be implemented in parallel. In this way, based on the CPU pipeline technology, parallel scheduling among multiple stages and among multiple types is realized by enabling threads in different processing stages. For a vehicle SoC (System on Chip) with limited computing power, it is of great engineering significance to improve the frame rate of the perception model.

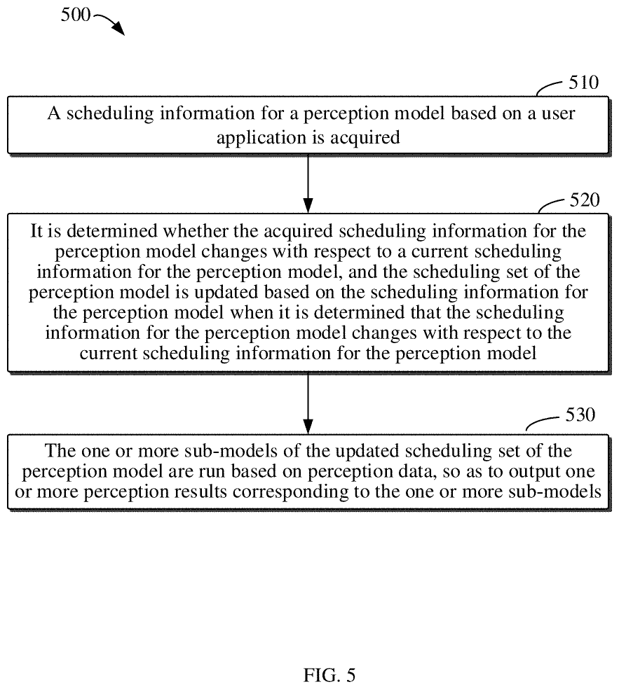

FIG. 5 shows a flowchart of another example of a method 500 for data processing according to embodiments of the present disclosure. In embodiments, the method 500 may be performed by system 200 shown in FIG. 2. The method 500 will be described below in combination with FIG. 2. It should be understood that the method 500 may further include additional blocks not shown, and/or the method 500 may omit some of the blocks shown. The scope of the present disclosure is not limited in this regard.

At block 510 similar to block 310 in the method 300, a scheduling information for a perception model based on a user application is acquired. Since acquiring the scheduling information for the perception model based on a user application has been described above in combination with FIG. 3, details will not be repeated here.

At block 520, it is determined whether the acquired scheduling information for the perception model changes with respect to a current scheduling information for the perception model. The scheduling set of the perception model is updated based on the scheduling information for the perception model when it is determined that the scheduling information for the perception model changes with respect to the current scheduling information for the perception model. Under a system framework with various user applications, different user applications are usually switched according to actual needs of the user. For example, the user may need automated parking into a private parking space or into a public parking space. In this case, updating the scheduling set of the perception model is necessary for a specific parking task.

At block 530, the one or more sub-models of the updated scheduling set of the perception model are run based on perception data from a data collection device, so as to output one or more perception results corresponding to the one or more sub-models. One or more sub-models of the updated scheduling set of the perception model may be run in the same or similar manner as shown in FIG. 3. In embodiments, the one or more sub-models of the updated scheduling set of the perception model may also be run in a manner different from that in FIG. 3. Alternatively or additionally, the one or more sub-models may be run in parallel when switching from a home parking application to a high-definition-map-based public parking application, so as to further reduce the delay. In another embodiment, running the one or more sub-models in serial and running the one or more sub-models in parallel may be freely combined according to different user applications. The scope of the present disclosure is not limited in this regard.

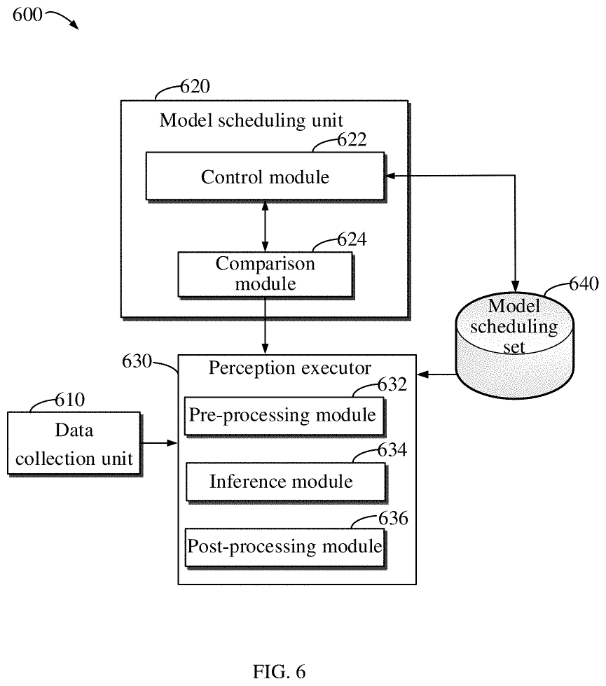

FIG. 6 shows a block diagram of an example of an apparatus for data processing according to embodiments of the present disclosure. In FIG. 6, the apparatus 600 may include a data collection unit 610, a model scheduling unit 620, a perception executor 630, and a storage device 640, which cooperate together for data processing. The storage device 640 is used to store a scheduling set of a model. The data collection unit 610 is used to collect perception data from a user environment. The model scheduling unit 620 is used to determine a scheduling set of a perception model in response to receiving a scheduling information for the perception model based on a user application, where the scheduling set of the perception model includes one or more sub-models of a plurality of sub-models of the perception model. The perception executor 630 is used to run, based on the perception data, the one or more sub-models of the plurality of sub-models, so as to output one or more perception results corresponding to the one or more sub-models.

In embodiments, the above-mentioned plurality of apparatuses may be implemented in different physical devices, respectively. Alternatively, at least a part of the above-mentioned plurality of apparatuses may be implemented in the same physical device. For example, the data collection unit 610, the model scheduling unit 620, and the perception executor 630 may be implemented in the same physical device, and the storage device 640 may be implemented in another physical device. The scope of the present disclosure is not limited in this regard.

In embodiments, the model scheduling unit 620 further includes a control module 622 and a comparison module 624. The control module 622 is used to select, from a model set, the one or more sub-models as the scheduling set of the perception model based on the scheduling information for the perception model. The comparison module 624 is used to determine whether the scheduling information for the perception model changes with respect to a current scheduling information for the perception model. The control module updates, based on the scheduling information for the perception model, the scheduling set of the perception model in response to determining that the scheduling information for the perception model changes with respect to the current scheduling information for the perception model.

In embodiments, the perception actuator 630 further includes a pre-processing module 632, an inference module 634, and a post-processing module 636. The pre-processing module 632 is used to process the perception data from the data collection device. The inference module 634 is used to perform perceptual internal processing on the pre-processed data based on a neural network model. The post-processing module 636 is used to parse and fuse the data from the inference module for sending to the client.

In embodiments, the perception executor 630 is further used to enable a plurality of threads to run the one or more sub-models, where the plurality of threads include pre-processing, model inference, and post-processing. In the case of the plurality of threads running in parallel, the perception executor 630 is further used to perform at least one selected from: running the one or more sub-models sequentially in turn, running the one or more sub-models selectively according to a model running frame rate, or running the one or more sub-models in parallel.

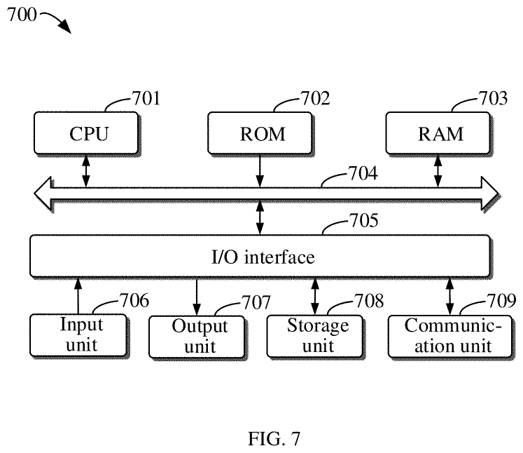

FIG. 7 shows a schematic block diagram of an exemplary device 700 used to implement embodiments of the present disclosure. For example, the one or more apparatuses in the system 200 shown in FIG. 2 and/or the data processing apparatus 600 shown in FIG. 6 may be implemented by the device 700. As shown in FIG. 7, the device 700 includes a central processing unit (CPU) 701 which may perform various appropriate actions and processing based on computer program instructions stored in a read-only memory (ROM) 702 or computer program instructions loaded from a storage unit 708 into random access memory (RAM) 703. Various programs and data required for the operation of the device 700 may also be stored in the RAM 703. The CPU 701, the ROM 702, and the RAM 703 are connected to each other through a bus 704. An input/output (I/O) interface 705 is also connected to the bus 704.

Various components in the device 700, including an input unit 706 such as a keyboard, a mouse, etc., an output unit 707 such as various types of displays, speakers, etc., a storage unit 708 such as a magnetic disk, an optical disk, etc., and a communication unit 709 such as a network card, a modem, a wireless communication transceiver, etc., are connected to the I/O interface 705. The communication unit 709 allows the electronic device 700 to exchange information/data with other devices through a computer network such as the Internet and/or various telecommunication networks.

The computing unit 701 may perform the various methods and processes described above, such as any of the method 300 and the method 400. For example, in embodiments, any of the method 300 and the method 400 may be implemented as a computer software program that is tangibly contained on a machine-readable medium, such as a storage unit 708. In embodiments, part or all of a computer program may be loaded and/or installed on the electronic device 700 via the ROM 702 and/or the communication unit 709. When a computer program is loaded into the RAM 703 and executed by the CPU 701, one or more steps in any of the method 300 and the method 400 described above may be executed. Alternatively, in embodiments, the CPU 701 may be configured to perform any of the method 300 and the method 400 in any other appropriate way (for example, by means of firmware).

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server. The server may be a cloud server, a server for distributed system, or a server combined with a blockchain.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

Furthermore, although operations are depicted in a particular order, this should be understood to require that such operations be performed in the particular order shown or in a sequential order, or that all illustrated operations should be performed to achieve desired results. Under certain circumstances, multitasking and parallel processing may be advantageous. Likewise, although the above discussion contains several implementation-specific details, these should not be construed as limitations on the scope of the present disclosure. Certain features that are described in the context of separate embodiments may also be implemented in combination in a single implementation. Conversely, various features that are described in the context of a single implementation may also be implemented in multiple implementations separately or in any suitable sub-combination.

Although the subject matter has been described in language specific to structural features and/or logical acts of method, it should be understood that the subject matter defined in the appended claims is not necessarily limited to the specific features or acts described above. Rather, the specific features and acts described above are merely example forms of implementing the claims.

Aspects disclosed herein may be embodied in hardware and instructions stored in hardware, and may reside, for example, in random access memory (RAM), flash memory, read only memory (ROM), electrically programmable ROM (EPROM), electrically erasable programmable ROM (EEPROM), registers, hard disk, removable disk, CD-ROM, or any other form of computer readable medium known in the art. An exemplary storage medium is coupled to the processor such that the processor may read information from, and write information to, the storage medium. Alternatively, the storage medium may be integrated with the processor. The processor and storage medium may reside in an ASIC. The ASIC may reside in a remote station. Alternatively, the processor and storage medium may reside as discrete components in a remote station, a base station, or a server.

What is claimed is:

1. A method for data processing, the method comprising:
acquiring a scheduling information for a perception model based on a user application;
determining, based on the scheduling information for the perception model, a scheduling set of the perception model, wherein the scheduling set of the perception model comprises one or more sub-models of a plurality of sub-models of the perception model; and
running, by a hardware computer and based on perception data from a data collection device, the one or more sub-models of the scheduling set of the perception model, so as to output one or more perception results corresponding to the one or more sub-models.

2. The method of claim 1, further comprising:
determining whether the acquired scheduling information for the perception model changes with respect to a current scheduling information for the perception model; and
updating, based on the scheduling information for the perception model, the scheduling set of the perception model in response to determination that the scheduling information for the perception model changes with respect to the current scheduling information for the perception model.

3. The method of claim 2, further comprising running the one or more sub-models of the updated scheduling set of the perception model.

4. The method of claim 1, wherein the one or more sub-models of the scheduling set of the perception model are run in parallel or in serial.

5. The method of claim 4, comprising running the one or more sub-models of the scheduling set of the perception model in serial and wherein running the one or more sub-models in serial comprises running the one or more sub-models sequentially in turn.

6. The method of claim 5, wherein the running the one or more models in serial further comprises running the one or more sub-models selectively according to a model running frame rate.

7. The method of claim 4, wherein running the one or more sub-models comprises enabling a plurality of threads, wherein the plurality of threads comprise pre-processing, model inference, and post-processing.

8. The method of claim 7, wherein the running the one or more sub-models further comprises running the one or more sub-models with the plurality of threads running in parallel.

9. The method of claim 2, wherein the one or more sub-models of the scheduling set of the perception model are run in parallel or in serial.

10. The method of claim 3, wherein the one or more sub-models of the scheduling set of the perception model are run in parallel or in serial.

11. An electronic device comprising:
at least one processor, and a storage device storing at least one program that, when executed by the at least one processor, enables the at least one processor to at least:
acquire a scheduling information for a perception model based on a user application;
determine, based on the scheduling information for the perception model, a scheduling set of the perception model, wherein the scheduling set of the perception model comprises one or more sub-models of a plurality of sub-models of the perception model; and
run, based on perception data from a data collection device, the one or more sub-models of the scheduling set of the perception model, so as to output one or more perception results corresponding to the one or more sub-models.

12. The electronic device of claim 11, wherein the at least one program is further configured to cause the at least one processor to:
determine whether the acquired scheduling information for the perception model changes with respect to a current scheduling information for the perception model; and
update, based on the scheduling information for the perception model, the scheduling set of the perception model in response to determination that the scheduling information for the perception model changes with respect to the current scheduling information for the perception model.

13. The electronic device of claim 12, wherein the at least one program is further configured to cause the at least one processor to run the one or more sub-models of the updated scheduling set of the perception model.

14. The electronic device of claim 11, wherein the one or more sub-models of the scheduling set of the perception model are run in parallel or in serial.

15. The electronic device of claim 14, wherein the at least one program is further configured to cause the at least one processor to run the one or more sub-models sequentially in turn.

16. The electronic device of claim 15, wherein the at least one program is further configured to cause the at least one processor to run the one or more sub-models selectively according to a model running frame rate.

17. The electronic device of claim 14, wherein the at least one program is further configured to cause the at least one processor to enable a plurality of threads, wherein the plurality of threads comprise pre-processing, model inference, and post-processing.

18. The electronic device of claim 17, wherein the at least one program is further configured to cause the at least one processor to run the one or more sub-models with the plurality of threads running in parallel.

19. The electronic device of claim 12, wherein the one or more sub-models of the scheduling set of the perception model are run in parallel or in serial.

20. A non-transitory computer-readable storage medium having computer instructions therein, the computer instructions, when executed by at least one processor, configured to cause the at least one processor to at least:
acquire a scheduling information for a perception model based on a user application;
determine, based on the scheduling information for the perception model, a scheduling set of the perception model, wherein the scheduling set of the perception model comprises one or more sub-models of a plurality of sub-models of the perception model; and
run, based on perception data from a data collection device, the one or more sub-models of the scheduling set of the perception model, so as to output one or more perception results corresponding to the one or more sub-models.
